(19) United States
(12) Patent Application Publication
(10) Pub. No.: US 2014/0183990 A1
(43) Pub. Date: Jul. 3, 2014

(54) ARRANGEMENT AND METHOD FOR COOLING AN ELECTRIC MACHINE

(71) Applicant: ABB Technology AG, Zurich (CH)

(72) Inventor: Pekka KANNINEN, Helsinki (FI)

(73) Assignee: ABB Technology AG, Zurich (CH)

(21) Appl. No.: 14/196,922

(22) Filed: Mar. 4, 2014

Related U.S. Application Data
(63) Continuation of application No. PCT/FI2012/050805, filed on Aug. 23, 2012.

(30) Foreign Application Priority Data
Sep. 1, 2011 (FI) 20115858

(51) Int. Cl. H02K 9/04; H02K 9/18; H02K 9/16

(52) U.S. Cl. CPC H02K 9/04; H02K 9/16; H02K 9/18
USPC 310/57; 310/62; 310/63; 310/59

(57) ABSTRACT

A method and an arrangement for cooling an electric machine, including an electric machine and at least one blower connected to an axle of the electric machine for blowing a cooling agent into the electric machine or for sucking it from the electric machine, wherein the at least one blower is a side channel blower.

### RELATED APPLICATION(S)

This application claims priority as a continuation application under 35 U.S.C. §120 to PCT/FI2012/050805, which was filed as an International Application on Aug. 23, 2012 designating the U.S., and which claims priority to Finnish Application 20115858 filed in Finland on Sep. 1, 2011. The entire contents of these applications can be hereby incorporated by reference in their entireties.

### FIELD

The disclosure relates to an arrangement and a method for cooling an electric machine.

### BACKGROUND INFORMATION

Electric machines, such as motors or generators, can be cooled by one or more blowers blowing a cooling agent into an electric machine or sucking a cooling agent therefrom. This enables a cooling agent circulation to be achieved around the electric machine and/or therethrough. The cooling agent can be air, for instance.

A cooling blower can be implemented as a separate blower such that the blower includes a motor of its own for driving the blower. Such a separate blower can be electrically driven and thus also can require a power supply of its own. With the use of a separate blower, if the power supply to the separate blower is interrupted, the cooling of the electric machine is also interrupted even if the electric machine itself does not necessarily stop. This can cause the electric machine to become overheated. Further, the separate blower and possible control units associated therewith can consume a relatively large space.

Another alternative for implementing a cooling blower for an electric machine is to use a cooling blower connected to an axle of the electric machine. In such a case, while rotating, the electric machine at the same time also drives the cooling blower connected to the axle, which means that the cooling is in operation whenever the electric machine rotates. A cooling blower connected to the axle of an electric machine can consume less space than a separate blower. Further, a cooling blower connected to an axle does not necessarily involve a separate bearing, for instance.

An example of a commonly used cooling blower connected to the axle of an electric machine is an axial blower which has a propeller type blade and which moves a cooling agent in a direction parallel to an axle around which the blower blade rotates. JP 2007089255 discloses another example of a cooling blower connected to the axle of an electric machine, the cooling blower in this case being a centrifugal blower. The centrifugal blower moves a cooling agent by centrifugal force radially with respect to a rotation axle of a blade wheel of the blower.

The above-described cooling blowers when connected to an axle, may not enable a sufficient pressure and/or flow of a cooling agent to be achieved, at low rotation speeds for example.

### SUMMARY

An arrangement for cooling an electric machine is disclosed, comprising: an electric machine; and at least one side channel blower connected to an axle of the electric machine for blowing a cooling agent into the electric machine or for sucking it from the electric machine.

A method of cooling an electric machine is disclosed, the method comprising: operating the electric machine; and blowing a cooling agent into the electric machine or sucking it from the electric machine by at least one side channel blower connected to an axle of the electric machine.

### BRIEF DESCRIPTION OF THE DRAWINGS

The disclosure is now described in closer detail in connection with the exemplary embodiments and with reference to the accompanying drawings, in which:

FIG. 1 shows an example of an arrangement for cooling an electric machine according to an exemplary embodiment of the disclosure;

FIG. 2 shows an example of an arrangement for cooling an electric machine according to an exemplary embodiment of the disclosure;

FIG. 3 shows an example of an arrangement for cooling an electric machine according to an exemplary embodiment of the disclosure;

FIG. 4 shows an example of a side channel blower according to an exemplary embodiment of the disclosure;

FIG. 5 shows an example of a side channel blower according to an exemplary embodiment of the disclosure;

FIG. 6 shows an example of a side channel blower according to an exemplary embodiment of the disclosure;

FIG. 7 shows an example of a rotor of a side channel blower according to an exemplary embodiment of the disclosure;

FIG. 8 shows an example of a part of a stator of a side channel blower according to an exemplary embodiment of the disclosure; and

FIG. 9 shows an example of a side channel blower according to an exemplary embodiment of the disclosure.

### DETAILED DESCRIPTION

According to exemplary embodiments of the disclosure, a cooling blower connected to an axle of an electric machine is a side channel blower.

Exemplary embodiments of the disclosure can enable a good cooling agent pressure generation and/or flow to be achieved already at a relatively low rotation speed. Further, the side channel blower can be made compact in structure.

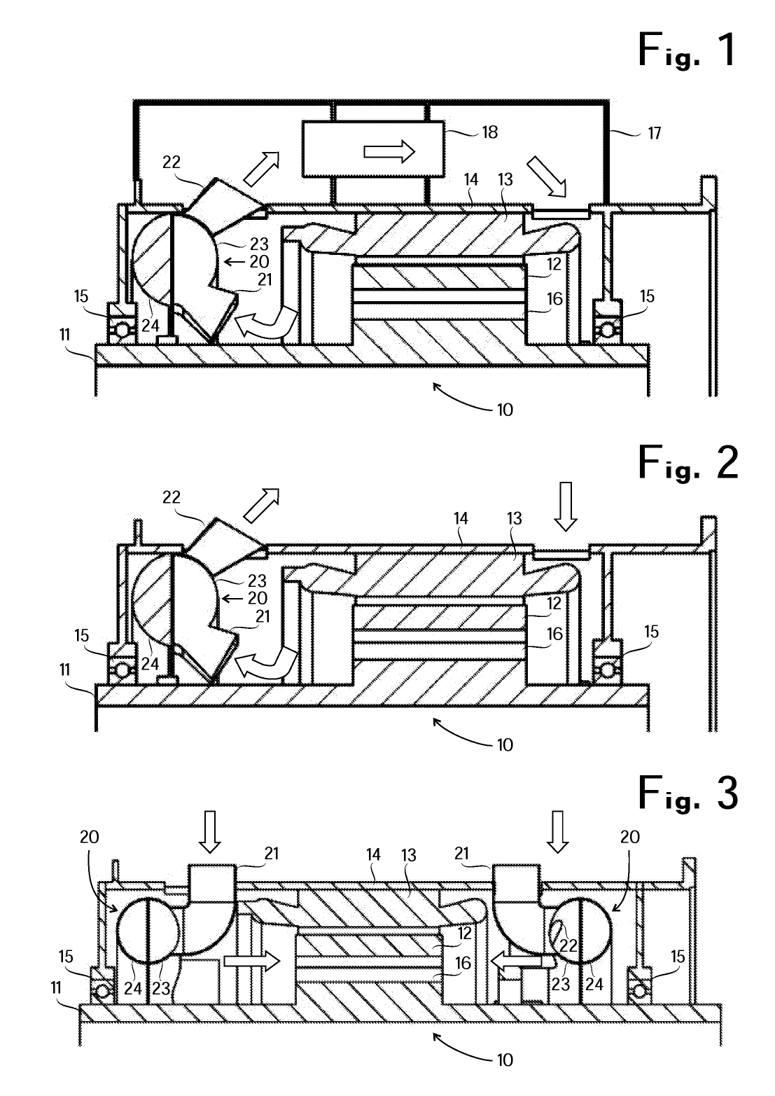

FIG. 1 shows an example of an arrangement according to an exemplary embodiment of the disclosure. FIG. 1 is a sectional view showing one half of the arrangement perpendicularly to an axle 11. It should be noted that the figure only shows elements relevant to the understanding of the disclosure.

The arrangement of FIG. 1 includes an electric machine 10 which can be a motor or a generator, for instance. Further, the electric machine 10 can be a synchronous machine or an asynchronous machine, or other suitable electrically driven device. The electric machine 10 includes an axle 11 and a rotor 12 fastened thereto. Ends of the axle 11 can be provided with bearings 15, enabling rotation of the axle 11 and the rotor 12. The electric motor 10 includes a stator 13 which can be fastened to a stator frame 14.

The arrangement of FIG. 1 further includes a side channel blower 20. The side channel blower 20 includes a stator 23 which can be fastened to the stator frame 14 of the electric machine 10, and a rotor 24 which is connected to the axle 11 of the electric machine 10 and thus rotates along with the axle 11 of the electric machine 10. The side channel blower 20 includes at least one cooling agent inlet opening 21 and at least one cooling agent outlet opening 22. The side channel blower 20 can include two or more cooling agent inlet openings 21 and two or more cooling agent outlet openings 22. The number of inlet openings 21 and outlet openings 22 can be for instance 2, 3, 4, 5, 6, 7, 8 or 9 or more. The number of both inlet openings 21 and outlet openings 22 can be the same.

By increasing the number of inlet openings 21 and outlet openings 22 of the side channel blower 20, cooling agent generation of the side channel blower 20 can be increased but correspondingly, cooling agent pressure generation decreases. The number of inlet openings 21 and outlet openings 22 can be selected each time according to the properties of an electric machine 10 being cooled and the operating conditions so as to enable the cooling of the electric machine 10 to be optimized. Similarly, the size and design of the inlet openings 21 and the outlet openings 22 can vary without this having any bearing on the basic idea of the disclosure.

The operation of the exemplary arrangement of FIG. 1 is based on a closed cooling agent circulation, whereby the arrangement includes at least one channel for conveying a cooling agent being discharged from the electric machine 10 back to the electric machine. In the example of FIG. 1, such a channel is formed inside an outer cover 17 of the electric machine. When the electric machine 10, and thus the side channel blower 20, can be in operation, the side channel blower 20 sucks the cooling agent from the electric machine 10 into one or more inlet openings 21 and further blows the cooling agent out of one or more outlet openings 22. The cooling agent circulation is designated by arrows in the figures. In the example of FIG. 1, the arrangement also includes at least one heat exchanger 18 for cooling a cooling agent when the cooling agent circulates through the heat exchanger 18. In the example of FIG. 1, the cooling agent passes through an air opening between the rotor 12 and the stator 13 of the electric machine 10 and/or through a rotor air duct 16, for instance. The cooling agent can be, for example, a gaseous cooling agent, such as air, or a cooling agent of another type.

FIG. 2 shows an arrangement according to an exemplary embodiment of the disclosure. The arrangement of FIG. 2 substantially corresponds to the example shown in FIG. 1 but the arrangement of FIG. 2 is based on an open cooling agent circulation. In the exemplary arrangement of FIG. 2, the cooling agent circulated through the electric machine 10 is blown via one or more outlet openings 22 of the side channel blower 20 into a space surrounding the electric machine 10. Similarly, the cooling agent is sucked into the electric machine 10 from the surrounding space.

It is to be noted that in the exemplary arrangements of FIGS. 1 and 2, the direction of the cooling agent circulation could also be opposite, in which case the side channel blower 20 would blow the cooling agent into the electric machine 10 rather than suck the cooling agent out of the electric machine 10. Also, more than one side channel blower 20 could be provided.

FIG. 3 shows an arrangement according to an exemplary embodiment of the disclosure. The arrangement of FIG. 3 otherwise corresponds to the example shown in FIG. 2 but the exemplary arrangement shown in FIG. 3 includes two side channel blowers 20, and the design of the inlet openings 21 and the outlet openings 22 of the side channel blowers 20 differs from the examples of FIGS. 1 and 2. Furthermore, in the example of FIG. 3 the side channel blowers 20 blow the cooling agent into the electric machine 10 in a manner shown by the arrows, symmetrically from both ends of the electric machine 10. It is to be noted that in the exemplary arrangement of FIG. 3, the direction of the cooling agent circulation could also be opposite. Also, only one side channel blower 20 could be provided in one or the other end of the electric machine 10.

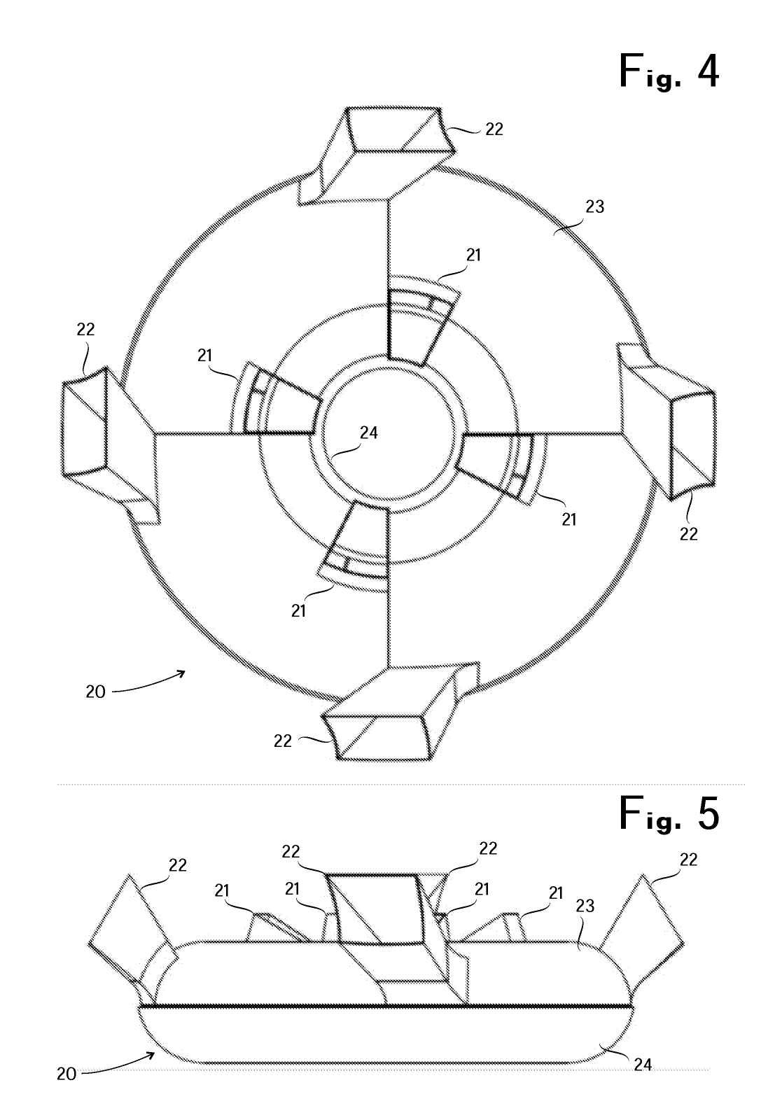

FIGS. 4 and 5 show a side channel blower 20 according to an exemplary embodiment of the disclosure, as viewed from different directions. The design of the cooling agent inlet openings 21 and the cooling agent outlet openings 22 of the side channel blower 20 of the example of FIGS. 4 and 5 substantially correspond to the examples shown in FIGS. 1 and 2. In the example of FIGS. 4 and 5, the number of inlet openings 21 and outlet openings 22 is four but the number of openings could also be greater or smaller than this. A middle part of the rotor 24 of the side channel blower 20 shown in FIG. 4 is fastened to the axle 11 of the electric machine to be cooled.

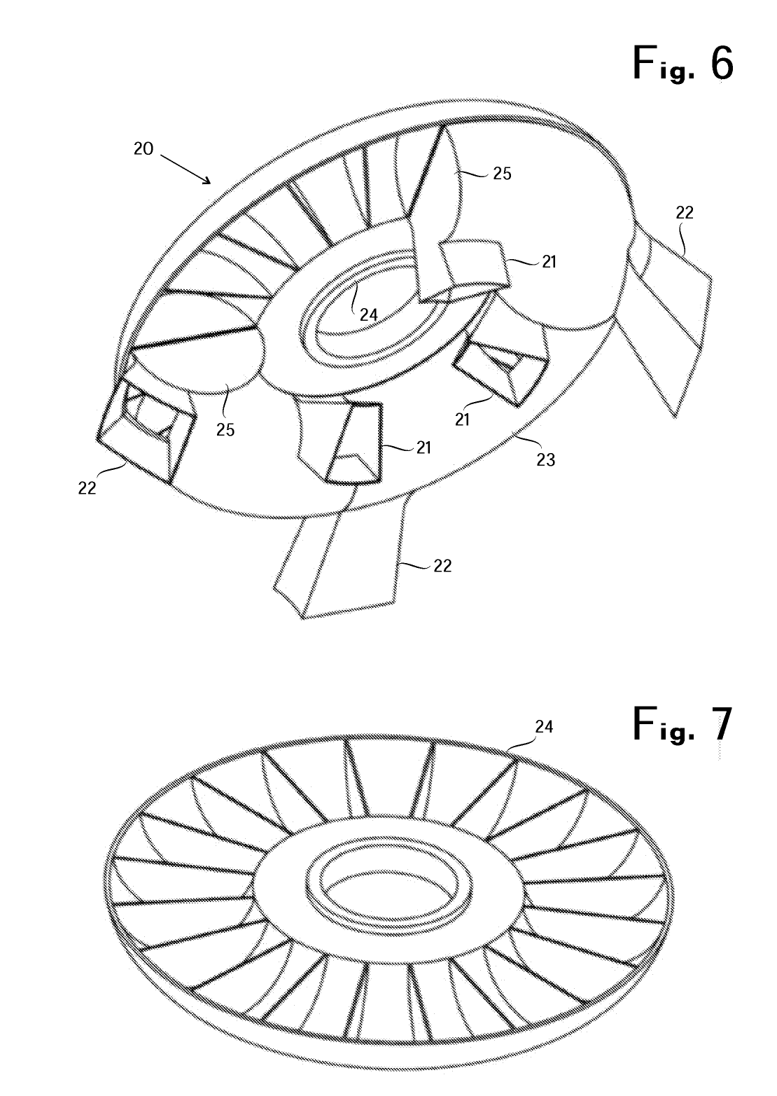

FIG. 6 is a partial sectional view of a side channel blower 20 according to an exemplary embodiment of the disclosure similar to that shown in FIGS. 4 and 5, wherein a quarter of the stator 23 is missing in order to show the structure of the rotor 24. The stator 23 of the side channel blower is a substantially hollow annular casing inside which an annular side channel of the side channel blowers is formed which runs along a side of the rotor 24 and opens up in the direction of the rotor 24. In other words, in the side channel blower 20 a side channel runs in a side direction (in the direction of the rotation axle of the rotor 24) substantially immediately adjacent to the rotor 24. Each cooling agent inlet opening 21 and each cooling agent outlet opening 22 of the side channel blower 20 open up into this side channel.

In the example of FIG. 6, where the number of inlet openings 21 and outlet openings 22 is four, the side channel is correspondingly divided into four sections by wall parts 25 between the sections such that each side channel section is provided with one inlet opening 21 and one outlet opening 22. The side channel can thus include two or more sections separated from one another, in which case, for example, at least one cooling agent inlet opening and at least one cooling agent outlet opening open up into each side channel section. The side channel can also include only one section provided with one inlet opening 21 and one outlet opening 22. In such a case, the side channel can travel an almost 360° circle from the inlet opening 21 to the outlet opening 22, a separating wall part 25 being provided therebetween to cut the side channel.

FIG. 7 shows an example of a rotor 24 of a side channel blower 20. The rotor 24 includes a number of blades which, as the rotor 24 rotates, cause a cooling agent flow from an inlet opening 21 and into an outlet opening 22. It is to be noted that the number and design of the blades of the rotor 24 can differ from the example of FIG. 7 without this having any bearing on the basic idea of the disclosure.

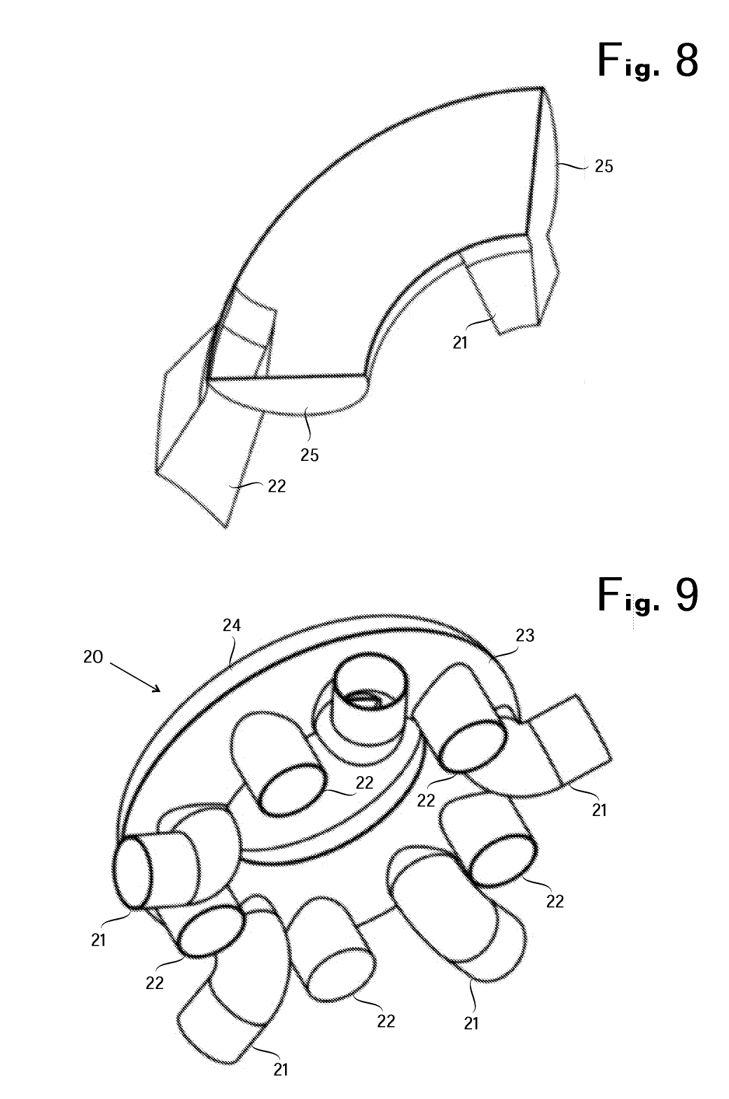

FIG. 8 shows an example of a part of a stator 23 of a side channel blower 20. The example of FIG. 8 corresponds to one quarter of the stator 23 of the side channel blower 20 shown in FIGS. 4 to 8, i.e. a whole stator 23 is formed by four interconnected pieces shown in FIG. 8. FIG. 8 shows the hollow structure of the stator 23 and a side channel formed therein, the cooling agent inlet opening 21 and the cooling agent outlet opening 22 opening up into this side channel. Thus, one quarter of the total length of the side channel of a side channel blower 20 similar to that shown in FIGS. 4 to 6 is formed inside the part of the stator 23 shown in FIG. 8.

FIG. 9 shows an example of a side channel blower 20 according to an exemplary embodiment of the disclosure. The side channel blower 20 of FIG. 9 otherwise corresponds to the examples shown in FIGS. 4 to 6 but the example shown in FIG. 9 includes five inlet openings 21 and outlet openings 22 and the design of the openings differs from the examples of FIGS. 4 to 6. The example of FIG. 9 thus substantially corresponds to the side channel blowers 20 according to the arrangement of FIG. 3. The number of inlet openings 21 and outlet openings 22 can differ from that shown in the figure.

Thus, it will be appreciated by those skilled in the art that the present invention can be embodied in other specific forms without departing from the spirit or essential characteristics thereof. The presently disclosed embodiments can be therefore considered in all respects to be illustrative and not restricted. The scope of the invention is indicated by the appended claims rather than the foregoing description and all changes that come within the meaning and range and equivalence thereof can be intended to be embraced therein.

What is claimed is:

1. An arrangement for cooling an electric machine, comprising:
an electric machine; and
at least one side channel blower connected to an axle of the electric machine for blowing a cooling agent into the electric machine or for sucking it from the electric machine.

2. The arrangement of claim 1, wherein the side channel blower comprises:
at least one cooling agent inlet opening; and
at least one cooling agent outlet opening.

3. The arrangement of claim 1, wherein the side channel blower comprises:
at least two cooling agent inlet openings; and
at least two cooling agent outlet openings.

4. The arrangement of claim 3, wherein the side channel blower comprises:
a rotor; and
an annular casing which forms a side channel running along a side of the rotor, whereby the at least one cooling agent inlet opening and the at least one cooling agent outlet opening open up into the side channel.

5. The arrangement of claim 4, wherein the side channel comprises:
at least two sections separated from one another, whereby at least one cooling agent inlet opening and at least one cooling agent outlet opening open up into each section of the side channel.

6. The arrangement of claim 1, wherein the arrangement is configured for an open circulation of the cooling agent.

7. The arrangement of claim 2, wherein the arrangement is configured for an open circulation of the cooling agent.

8. The arrangement of claim 5, wherein the arrangement is configured for an open circulation of the cooling agent.

9. The arrangement of claim 1, wherein the arrangement is configured for a closed circulation, comprising:
at least one channel for conveying cooling agent being discharged from the electric machine back to the electric machine.

10. The arrangement of claim 5, wherein the arrangement is configured for a closed circulation, comprising:
at least one channel for conveying cooling agent being discharged from the electric machine back to the electric machine.

11. The arrangement of claim 9, wherein the at least one channel comprises:
at least one heat exchanger for cooling the cooling agent.

12. The arrangement of claim 1, wherein the electric machine is a motor or a generator.

13. A method of cooling an electric machine, the method comprising:
operating the electric machine; and
blowing a cooling agent into the electric machine or sucking it from the electric machine by at least one side channel blower connected to an axle of the electric machine.

14. The method of claim 13, comprising:
providing an open circulation of the cooling agent.

15. The method of claim 13, comprising:
providing a closed circulation of the cooling agent; and
conveying cooling agent discharged from the electric machine back to the electric machine.

16. The method of claim 15, comprising:
cooling the cooling agent being discharged from the electric machine by at least one heat exchanger prior to conveying the cooling agent back to the electric machine.
